(19) United States
(12) Patent Application Publication
(10) Pub. No.: US 2011/0008986 A1
(43) Pub. Date: Jan. 13, 2011

(54) USB Receptacle and Plug Connecting Device

(75) Inventors: Terry Todd Thom, Otis Orchards, WA (US); Daniel Patrick Dunne, Liberty Lake, WA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: General Dynamics C4 Systems, Inc., Spokane Valley, WA (US)

(21) Appl. No.: 12/500,902

(22) Filed: Jul. 10, 2009

(51) Int. Cl. H01R 13/62

(52) U.S. Cl. 439/347

(57) ABSTRACT

A USB connection device that is capable of holding a USB receptacle and a USB plug, where the USB receptacle and USB plug are capable of mating inside the USB connection device. In some embodiments, the USB connection device comprises a housing having an upper wall, a lower wall, two side walls, at least one open side, and a protruding lever. The upper wall and the bottom wall have interior surfaces with a plurality of ridges and a plurality of slanted ridge walls capable of compressing a plurality of spring arms on a USB receptacle. The upper and bottom walls also have a plurality of pockets that allow the spring arms to de-compress. The device is capable of moving from side-to-side when a force is applied to the protruding lever, and the device is capable of retaining the USB receptacle and a mated USB plug during the side-to-side movement.

### FIELD OF THE INVENTION

The present invention relates generally to the field of electrical connectors and in particular to the retention of a universal serial bus (“USB”) plug mated to a USB receptacle.

### BACKGROUND OF THE INVENTION

USB systems are the modern standard for connecting peripheral electronic devices to computers or other electronic devices. Most modern computers have at least one USB receptacle (also referred to as a “port”) and many feature two or more USB receptacles. USB receptacles are also found on many other electronic devices including personal digital assistants (“PDAs”), video game consoles, digital cameras, televisions, cell phones, home stereo equipment, and many other devices. These USB receptacles connect the electronic devices to peripheral electronic devices such as keyboards, microphones, video cameras, mice, game controllers, scanners, faxes, external data storage devices (e.g., flash drives, external hard drives, etc.), printers, etc. Some peripheral electronic devices are designed to be connected and disconnected from the computer or electronic device in a plug-and-play arrangement. Some users, however, desire to keep peripheral electronic devices connected all the time to the computer or electronic device.

USB plugs are held in place by the gripping force from the USB receptacle's spring arms and do not need the screws, clips, etc., that other electric connectors require. The force needed to make or break a connection between a USB plug and a USB receptacle is quite modest.

It is to be understood that both the foregoing general description and the following detailed description are exemplary and explanatory only, and are not restrictive of the invention as claimed. The accompanying drawings constitute a part of the specification, illustrate certain embodiments of the invention and, together with the detailed description, serve to explain the principles of the invention.

### SUMMARY OF THE INVENTION

The invention generally relates to a USB connection device that is capable of holding a USB receptacle and a USB plug, where the USB receptacle and USB plug are capable of mating inside the USB connection device. In some embodiments, the USB connection device comprises a housing having an upper wall, a lower wall, two side walls, at least one open side, and a protruding lever. The upper wall and the bottom wall have interior surfaces with a plurality of ridges and a plurality of slanted ridge walls capable of compressing a plurality of spring arms on a USB receptacle. The upper and bottom walls also have a plurality of pockets that allow the spring arms to de-compress. The device is capable of moving from side-to-side when a force is applied to the protruding lever, and the device is capable of retaining the USB receptacle and a mated USB plug during the side-to-side movement.

Other aspects and advantages of the invention will become apparent from the following description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 depicts a frontal view of a plug connector.

FIG. 2 depicts an overhead perspective view of a plug.

FIG. 3 depicts an overhead perspective view of a plug and a receptacle.

FIG. 4 depicts an overhead perspective view of a receptacle.

FIG. 5 depicts a rear perspective view of a USB connection device according to an embodiment of the invention.

FIG. 6 depicts a front perspective view of a USB connection device according to an embodiment of the invention.

FIG. 7 depicts a front perspective view of a USB connection device connected with a receptacle according to an embodiment of the invention.

FIG. 8 depicts a front cross-sectional detailed view of a USB connection device connected with a receptacle that is mated to a plug in the unlocked position according to an embodiment of the invention.

FIG. 9 depicts a front cross-sectional detailed view of a USB connection device connected with a receptacle that is mated to a plug in the locked position according to an embodiment of the invention.

### DETAILED DESCRIPTION OF THE INVENTION

While USB systems have become the standard for connecting peripheral devices to electronic devices, there are some downsides with the design of the connectors. For example, USB receptacles are known in the art to have a low retention force due to the spring arms that connect the two mating parts, i.e., the plug and the receptacle. While the force needed to make or break a connection between a plug and a receptacle is minimal, allowing connections to be made in awkward circumstances or by people with motor disabilities, this can create a problem when connections are easily and unintentionally broken. Furthermore, USB plugs are known to become dislodged and fall out of the electronic device when subjected to vibration or unintended lateral force. This can lead to a loss of connectivity and data transmission between the peripheral device and the electronic device. In some cases, the dislodgement can result in the loss of the peripheral device. For example, flash drives (also referred to as thumb drives) can disconnect from a USB receptacle when shaken or jarred, and the owner might lose the drive if they are not attentive.

Attempts have been made to solve this problem by using various attachment means (e.g., duct tape, electrical tape, etc.) to secure the USB receptacle and plug together. Other inventions, such as the invention described in U.S. Pat. No. 7,128,595 to Boutros, have attempted to solve this problem by providing a flexible locking member that engages both the USB receptacle and plug. There are drawbacks with both of these solutions, however, as the tape attachment means does not allow for easy separation and oftentimes leaves a sticky residue, and the flexible locking mechanism may become bent out of shape with repeated use or break off entirely when excessive force is applied.

Therefore, it would be desirable to provide a device that allows a positive locking mechanism for a USB receptacle to a USB plug while maintaining a high retention force between the receptacle and the plug.

Exemplary embodiments of the present invention will hereinafter be described in detail with reference to the accompanying drawings.

Some embodiments of the present invention address the above problems by providing a device that comes in one solid piece and slides over the USB receptacle (also known as a “port”), and then slides side-to-side to create a lock between the USB receptacle and the USB plug. The device provides a higher retention force than the springs alone and helps prevent unintentional disconnection of the USB plug from the USB receptacle. Some embodiments of the present invention have the ability to adopt to any USB device including those using different USB types includes USB-A, USB-B, Mini-B, Micro-A, and Micro-B.

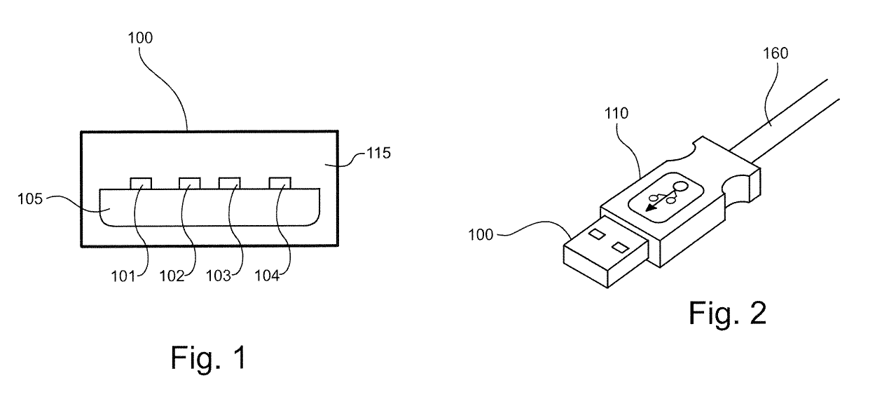

FIG. 1 depicts an embodiment of a plug connector 100 that is known in the art. The plug connector 100 has four pins 101-104 that are connected to a pin pad 105 and are either integrally formed to the plug connector 100 or otherwise attached to it by various attachment means known in the art, such as by welding, screws, etc. A contact opening 115 allows the plug connector 100 to mate with a receptacle 150.

FIG. 2 depicts an embodiment of a USB plug 110 that is known in the art. The plug 110 has a cable 160 or other means of connecting it with a peripheral electronic device such as a keyboard, microphone, video camera, mouse, game controller, scanner, fax, external data storage device (e.g., a flash drive or an external hard drive), a printer, etc.

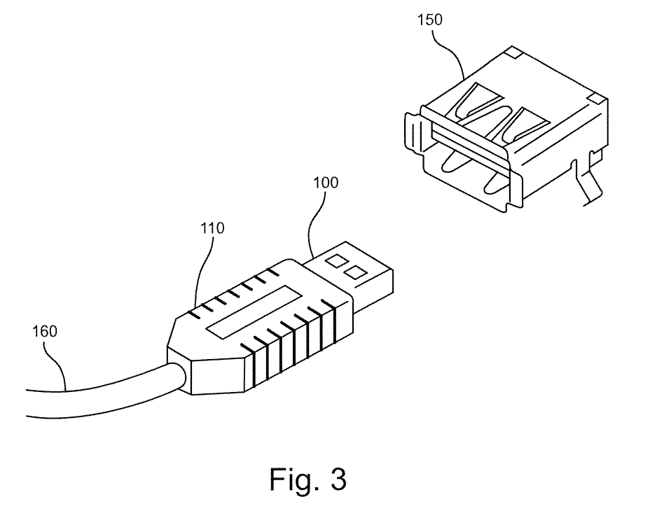

FIG. 3 depicts an embodiment of a plug 110 and a receptacle 150 that are known in the art. The receptacle 150 connects to an electronic device by cable or other means and communicates with the peripheral electronic device connected to the plug 110 by communication means known in the art. The receptacle 150 is designed to mate with the plug connector 100.

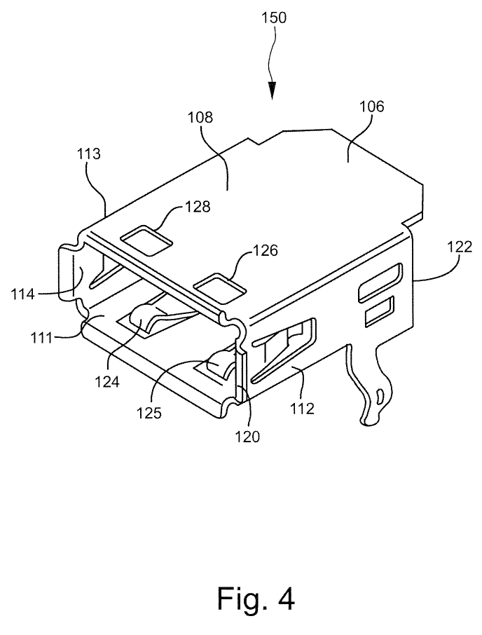

FIG. 4 depicts an embodiment of a USB Type-A receptacle 150 that is known in the art. The receptacle 150 includes a shell 106 with a bottom wall 111 and a top wall 108, and sidewalls 112 and 113 that extend between the bottom wall 110 and the top wall 108. The bottom wall 111, top wall 108, and sidewalls 112 and 113 define an inner area 114 that supports spring arms 124 and 125 on the bottom wall 111, and spring arms 126 and 128 on the top wall 108. The inner area 114 also has a receptacle connector 129 that mates with the contact opening 115 of the plug connector 100. The receptacle connector 129 and the spring arms 124, 125, 126, and 128 are either integrally formed to the inner area 114, or otherwise attached by welding, screws, or other attachment means. The receptacle 150 has opposite ends—front end 120 and back end 122. The front end 120 is open to receive the plug 110. The back end 122 has a cable 131 or other means of connecting it with an electronic device such as a computer or other hardware interface. Spring arms 124, 125, 126, and 128 grip the plug connector 100 when received in the inner area 114 and connect to the pins 101-104, thus allowing communication between the peripheral electronic device connected to the plug 100 and the electronic device connected to the receptacle 150.

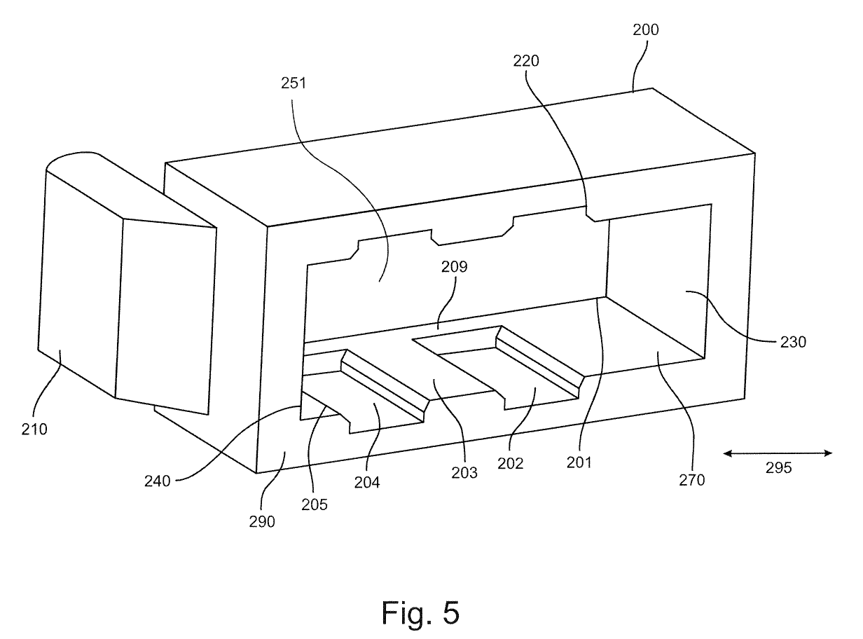

FIG. 5 depicts one embodiment of the present invention. The USB connection device 200 has a lever 210 on the side of the device that allows it to slide side-to-side 295 [symbol] . The lever 210 is spaced apart from the rear 290 of the USB connection device 200. This allows the lever 210 to be placed in an electronic device or computer and move freely side-to-side 295 [symbol] without being stopped by the body of the electronic device.

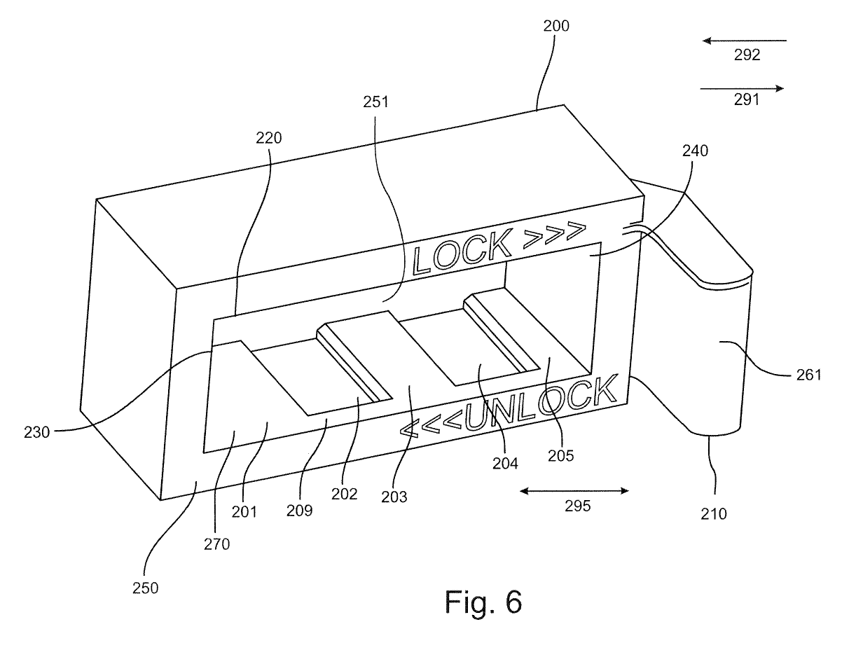

FIG. 6 depicts one embodiment of the present invention. The USB connection device 200 has a bottom interior wall 270, a top interior wall 220, and two side walls 230 and 240. The bottom interior wall 270, a top interior wall 220, and two side walls 230 and 240 define the interior area 251 of the USB connection device 200. In one embodiment of the device 200, there are three ridges 201, 203, and 205 on the bottom interior wall 210. The front 250 of the USB connection device 200 has a rectangular front bar 209 that is in front of pockets 202 and 204 and flush with ridges 201, 203, and 205. The lever 210 has a rounded tip 261 that protrudes from the face 250 of the USB connection device 200 and allows a user to better manipulate and apply force to slide the device 200 side-to-side 295 [symbol] . In other embodiments of the invention, the device 200 is capable of sliding up and down [symbol] .

In one exemplary embodiment, a user slides the USB connection device 200 by applying force to the lever 210. In some embodiments, a user slides the lever 210 to the user's right 291 → to lock the plug 110 and the receptacle 150 together. In other embodiments, a user slides the lever 210 to user's left 292 ← to lock the plug 110 and the receptacle 150 together. To unlock the plug 110 and the receptacle 150, a user pushes or pulls the lever 210 on the USB connection device 200 in the opposite direction required to lock the plug 110 and receptacle 150 together.

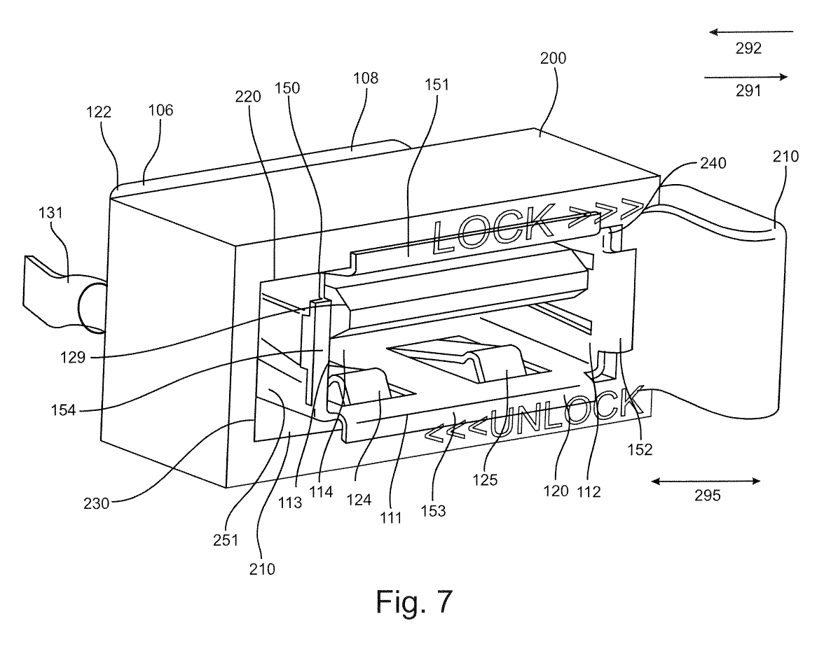

FIG. 7 depicts an exemplary embodiment of the device where the USB connection device 200 is mated with the receptacle 150. The receptacle 150 takes up most of the interior area 251 of the USB connector device 200. The bottom wall 111, top wall 108, and sidewalls 112 and 113 of the receptacle fit into the interior area 251 of the USB connector device 200, with the bottom wall 111 and top wall 108 secured to the bottom interior wall 210 and the top interior wall 220 of the USB connection device 200. In some embodiments of the device, the receptacle 150 has extensions 151-154 that are positioned on the bottom wall 111, top wall 108, and side walls 112 and 113 to overlap a portion of the external faces of the USB connection device 200.

In some embodiments of the invention, the extensions 151-154, like the receptacle 150, are made out of either plastic, metal, or a combination thereof.

The receptacle 150 is placed into the USB connection device 200 with the front end 120 oriented facing the plug 110, with the back end 122 having a cable 131 extending from the receptacle 150 to the electronic device. The receptacle connector 129 is configured to be able to mate with the contact opening 115 of the plug connector 100. In the embodiment depicted in FIG. 7, the spring arms 124, 125, 126, and 128 are fully extended because the side wall 240 next to the lever 210 is flush with the side wall 112 of the receptacle 150. In this configuration, the receptacle 150 is unlocked and able to receive a plug 110. To lock the receptacle 150, a user applies force on the lever 210 in the opposite direction required to unlock the receptacle 150 from the USB connection device 200.

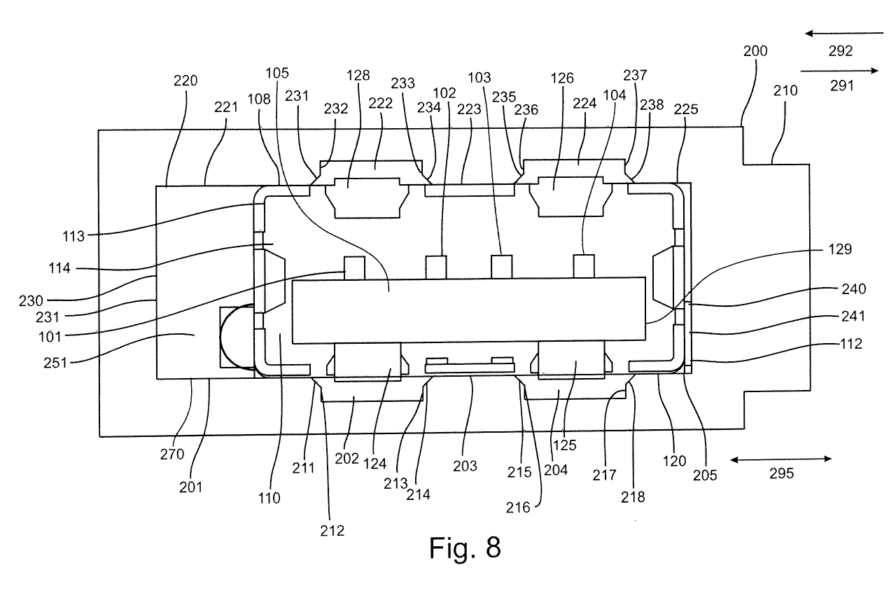

FIG. 8 depicts an exemplary embodiment of the invention where the plug 110 is mated with the receptacle 150 inside the USB connection device 200 in an unlocked position. In one embodiment of the invention, the unlocked position is on side wall 240 of the USB connection device 200, or, in other words, on the proximal side 241 of the USB connection device 200 in relation to the lever 210.

In the unlocked position, the spring arms 124, 125, 126, and 128 of the receptacle 150 are at rest in the pockets 202, 204, 222, and 224 as there is no tension or force applied to them. The spring arms 124, 125, 126, and 128 are not in contact with the interior walls 212, 213, 216, 217, 232, 233, 236, and 237 of the pockets 202, 204, 222, and 224, and are not close to touching the slanted ridge walls 211, 214, 215, 218, 231, 234, 235, and 238. A user applying force to the lever 210 in the locking direction causes the spring arms 124, 125, 126, and 128 to become depressed when they come into contact with the slanted ridge walls 211, 214, 215, 218, 231, 234, 235, and 238 at the corners of the pockets 202, 204, 222, and 224, and locks the spring arms 124, 125, 126, and 128 in a compressed position on the ridges 201, 203, 221, and 223. This causes the locking of the receptacle 150 and the plug 110 inside the USB connection device 200.

As depicted in FIG. 8, the receptacle connector 129 is mated with the contact opening 115 of the plug 110. When the USB connection device 200 is in the unlocked position, the connection between the plug 110 and the receptacle 150 has the same retention force as when the plug 110 and the receptacle 150 are not mated inside the USB connection device 200. In other words, the force needed to break a connection between the plug 110 and the receptacle 150 when they are unlocked in the USB connection device 200 is modest.

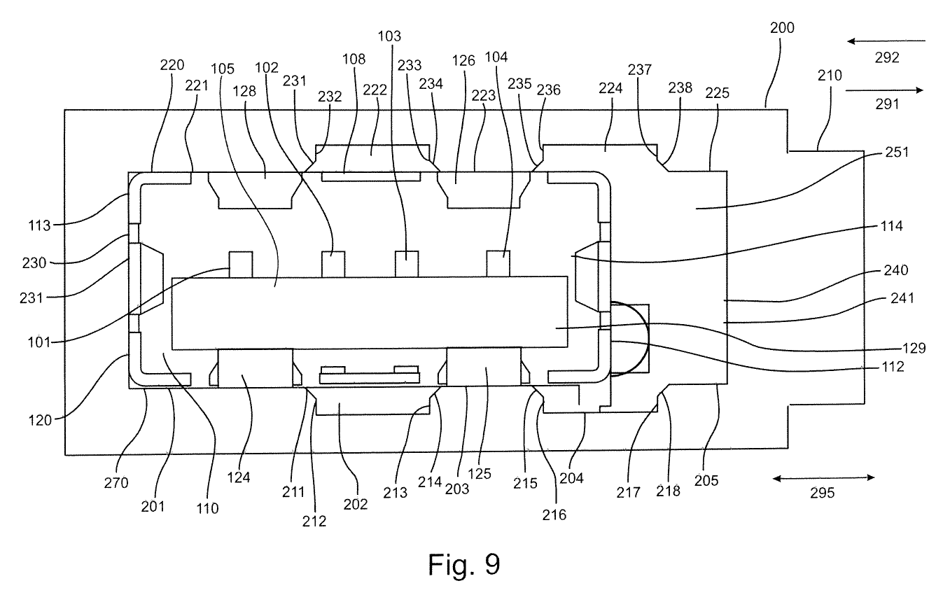

FIG. 9 depicts an exemplary embodiment of the invention where the plug 110 is mated with the receptacle 150 inside the USB connection device 200 in the locked position. In one embodiment of the invention, the locked position is on side wall 230 of the USB connection device 200, or, in other words, on the distal side 231 of the USB connection device 200 in relation to the lever 210.

In the locked position, the spring arms 124, 125, 126, and 128 of the receptacle 150 are compressed on the ridges 201, 203, 221, and 223. In one embodiment of the invention, a user locks the plug 110 and the receptacle 150 together by applying a force to the lever 210 towards the user's right 291 → (i.e., towards the proximal side 241 of the USB connection device 200). This moves the USB connection device 200 in a direction that causes the spring arms 124, 125, 126, and 128 on the receptacle 150 to move from full extension to compression when they come into contact with the slanted ridge walls 211, 215, 231, and 235 of the USB connection device 200. The spring arms 124, 125, 126, and 128 become more compressed as they travel further onto the slopes of the slanted ridge walls 211, 215, 231, and 235, and finally become fully compressed on ridges 201, 203, 221, and 223.

To release the tension on the spring arms 124, 125, 126, and 128, thus unlocking the plug 110 and the receptacle 150 from one another, a user applies an unlocking force towards the user's left 292 ← (i.e., towards the distal side 231 of the USB connection device 200). The plug 110 and the receptacle 150 are unlocked when the spring arms 124, 125, 126, and 128 are no longer engaged by the ridges 201, 203, 221, and 223 or the slanted ridge walls 211, 215, 231, and 235. Thus, in the unlocked position, the spring arms 124, 125, 126, and 128 are in between interior walls 212, 213, 216, 217, 232, 233, 236, and 237 and the spring arms 124, 125, 126, and 128, and are fully extended in pockets 202, 204, 222, and 224.

When the USB connection device 200 is in the locked position, the connection between the plug 110 and the receptacle 150 has a much higher retention force that is much harder to break than when the plug 110 and the receptacle 150 are not mated and locked inside the USB connection device 200. In other words, the force needed to disconnect the plug 110 and the receptacle 150 when they are locked in the USB connection device 200 is much higher than in the unlocked position depicted in FIG. 8.

While the invention has been described in connection with what is presently considered to be exemplary embodiments, it is to be understood that the invention is not limited to the disclosed embodiments. On the contrary, the invention is intended to cover various modifications and equivalent arrangements included within the spirit and scope of the following claims.

1. A USB connection device that is capable of holding a USB receptacle and a USB plug, the USB receptacle and USB plug being capable of mating inside the USB connection device, the USB connection device comprising:
a housing having an upper wall, a lower wall, two side walls, at least one open side, and a protruding lever for moving the device from side to side;
the upper wall and the bottom wall having interior surfaces with a plurality of ridges and a plurality of slanted ridge walls capable of compressing a plurality of spring arms on a USB receptacle when the device is moved from side to side, and a plurality of pockets that allow the spring arms to de-compress;
wherein said device is capable of moving from side-to-side when a force is applied to the protruding lever; and
wherein said device is capable of retaining the USB receptacle and a mated USB plug during the side-to-side movement.

2. The device of claim 1, wherein the USB receptacle and the mated USB plug are locked together by the application of a force on the lever in a direction proximal to the lever, thereby causing the spring arms to become compressed as they contact the slanted ridge walls and ridges of the upper and bottom walls.

3. The device of claim 1, wherein the USB receptacle and the mated USB plug are unlocked from one another by the application of a force on the lever in a direction distal to the lever, thereby causing the spring arms to become de-compressed as they lose contact with the slanted ridge walls and ridges of the upper and bottom walls and move into position between a plurality of interior walls that define the pockets.

4. The device of claim 1, wherein there are six ridges on the upper and bottom walls.

5. The device of claim 4, wherein there are three ridges on the upper wall, and three ridges on the lower wall.

6. The device of claim 1, wherein there are four pockets on the upper and bottom walls.

7. The device of claim 6, wherein there are two pockets on the upper wall, and two pockets on the bottom wall.

8. The device of claim 1, wherein there are eight slanted ridge walls on the upper and bottom walls.

9. The device of claim 8, wherein there are four slanted ridge walls on the upper wall, and four slanted ridge walls on the bottom wall.

10. The device of claim 1, wherein there are eight interior walls on the upper and bottom walls.

11. The device of claim 10, wherein there are four interior walls on the upper wall, and four interior walls on the bottom wall.

12. (canceled)

13. The device of claim 1, wherein the device is capable of receiving the USB plug when the USB receptacle is in the unlocked position in the device.

14. The device of claim 1, wherein there is at least one rectangular bar on at least one of the open sides that is aligned with the ridges and positioned between the side walls.

15. The device of claim 1, wherein the USB receptacle has extensions that overlap a portion of an outside area of the top and bottom walls and the side walls.

16. The device of claim 1, wherein the housing further comprises a side wall.

17. The device of claim 1, wherein the housing further comprises two side walls.
